(19) United States
(12) Patent Application Publication
(10) Pub. No.: US 2023/0037871 A1
(43) Pub. Date: Feb. 9, 2023

(54) BATTERY MODULE AND BATTERY PACK INCLUDING THE SAME

(71) Applicant: LG ENERGY SOLUTION, LTD., Seoul (KR)

(72) Inventors: Changhun LEE, Daejeon (KR); Junyeob SEONG, Daejeon (KR); Myungki PARK, Daejeon (KR); Youngho LEE, Daejeon (KR); Junkyu PARK, Daejeon (KR); Soo Youl KIM, Daejeon (KR)

(21) Appl. No.: 17/790,092

(22) PCT Filed: Mar. 9, 2021
(86) PCT No.: PCT/KR2021/002921

§ 371 Date: Jun. 29, 2022

(30) Foreign Application Priority Data
Apr. 29, 2020 (KR) 10-2020-0052255

(51) Int. Cl. H01M 50/505; H01M 50/211; H01M 50/202

(52) U.S. Cl. CPC H01M 50/505; H01M 50/211; H01M 50/202; H01M 2220/20

(57) ABSTRACT

A battery module and a battery pack including the same. The battery module includes: a battery cell stack including a plurality of battery cells; a frame surrounding the battery cell stack; a busbar frame covering the front/rear surfaces of the battery cell stack that are exposed from the frame; and an end plate covering the busbar frame. The frame includes a lower frame covering the lower part and both sides of the battery cell stack, and an upper plate covering the upper part of the battery cell stack, and at least one assembly guide part formed at the corner of the lower frame that joins the upper plate.

### CROSS-REFERENCE TO RELATED APPLICATIONS

This application is a US national phase of international application No. PCT/KR2021/002921 filed on Mar. 9, 2021, and claims priority to and the benefit of Korean Patent Application No. 10-2020-0052255 filed in the Korean Intellectual Property Office on Apr. 29, 2020, the entire contents of which are incorporated herein by reference.

### TECHNICAL FIELD

The present invention relates to a battery module and a battery pack including the same, and more specifically, to a battery module with improved assembly ability and a battery pack including the same.

### BACKGROUND

Secondary batteries having high application characteristics and electrical characteristics such as high energy density are widely applied to battery vehicles, hybrid vehicles, and electric power storage devices driven by electric driving sources, as well as portable devices. These secondary batteries are attracting attention as new energy sources for improving environmental-friendliness and energy efficiency in that they do not generate any by-products of energy use as well as their primary merit, in which they can drastically reduce the use of fossil fuels.

In small mobile devices, one, or two, or three battery cells are used per device, while medium and large devices such as automobiles require high power/large capacity. Therefore, a medium-to-large battery module in which a plurality of battery cells are electrically connected is used.

Since it is preferable for medium and large battery modules to be manufactured with as small a size and weight as possible, a prismatic battery and a pouch-type battery, which may have a high integration degree and have a small weight with respect to capacity, are mainly used as a battery cell of the medium and large battery modules. Meanwhile, in order to protect the cell stack from external impact, heat, or vibration, the battery module may include a frame with front and rear openings that includes the battery cell stack in an internal space therein.

FIG. 1 is a perspective view of a battery module according to a conventional battery module frame. FIG. 2 is a cross-sectional view along an xz plane of FIG. 1.

As illustrated in FIG. 1 and FIG. 2, a battery module may include a frame 10, which includes a front surface and a rear surface that are opened to cover a battery cell stack 12 formed by stacking a plurality of battery cells 11 and an end plate 20 covering the front surface and the rear surface of the module frame 10. The module frame 10 may include a U-shaped frame 10a and an upper plate 10b covering the opened portion of the U-shaped frame 10a. The U-shaped frame 10a may include a bottom part 10a1 covering the lower surface of the battery cell stack 12 and two side parts 10a2 protruding upward from both sides of the bottom part 10a1, respectively. The end plate 20 may include a front plate 20a covering one side of the frame 10 and a rear plate 20b covering the other side of the frame 10.

To form such a battery module, where the battery cell stack 12 is mounted inside the frame 10, welding may be performed to join the U-shaped frame 10a and the upper plate 10b of the frame 10. In this case, an assembly failure may occur during the assembling process in which the upper plate 10b is placed on the U-shaped frame 10a. Particularly, when a welding part WP is formed between the upper plate 10b and the side part of the U-shaped frame 10a, a guide for assembly alignment is not provided, which may cause defects.

Therefore, there is a need for a technology that can solve this problem of conventional art.

### SUMMARY

The problem to be solved by the present invention is to provide a battery module with improved assembly ability and a battery pack including the same.

Objectives to be achieved by the embodiments of the present invention are not limited to the above-mentioned objective, and can be variously extended within the scope of the technical idea included in the present invention.

A battery module according to an exemplary embodiment of the present invention includes a battery cell stack in which a plurality of battery cells are stacked; a frame surrounding the battery cell stack; a busbar frame covering the front/rear surfaces of the battery cell stack exposed from the frame; and an end plate covering the busbar frame, wherein the frame includes a lower frame covering the lower surface and both side surfaces of the battery cell stack, and an upper plate covering the upper part of the battery cell stack, and at least one assembly guide part formed at the corner of the lower frame that joins the upper plate.

The lower frame may include a bottom part supporting the lower part of the battery cell stack and two side parts extending upward from both ends of the bottom part, respectively, and the assembly guide part may be formed at the corner of the upper end of the side part.

The assembly guide part may include a supporting part that protrudes in one direction and a depressed part formed on both sides of the supporting part.

The depressed part may have an escape shape in which the upper end corner of the side part of the lower frame is concave in the direction toward the bottom part of the lower frame.

A groove part to which the supporting part of the assembly guide part may be connected is formed on the upper plate.

The groove part may have a structure in which both corresponding corners of the upper plate are recessed in a direction facing each other.

An escape part may be formed on both ends of the groove part.

A battery pack according to another embodiment of the present invention includes the battery module described above.

According to exemplary embodiments, by forming a protruding-type assembly guide structure in the frame, it is possible to prevent a misalignment from occurring when assembling the frame. Through this assembly improvement, it is possible to prevent welding defects from occurring during a module frame welding.

### BRIEF DESCRIPTION OF THE DRAWINGS

FIG. 1 is a perspective view of a battery module having a conventional frame.

FIG. 2 is a cross-sectional view along an xz plane of FIG. 1.

FIG. 3 is an exploded perspective view of a battery module according to an exemplary embodiment of the present invention.

FIG. 4 is a perspective view of a lower frame included in a battery module of FIG. 3.

FIG. 5 is a partial perspective view of an assembly part of an upper plate and a lower frame in a battery module according to an embodiment of the present invention.

### DETAILED DESCRIPTION

The present invention will be described more fully hereinafter with reference to the accompanying drawings, in which exemplary embodiments of the invention are shown. As those skilled in the art would realize, the described exemplary embodiments may be modified in various different ways, all without departing from the spirit or scope of the present invention.

Descriptions of parts not related to the present invention are omitted, and like reference numerals designate like elements throughout the specification.

Further, since sizes and thicknesses of constituent members shown in the accompanying drawings are arbitrarily given for better understanding and ease of description, the present invention is not limited to the illustrated sizes and thicknesses. In the drawings, the thickness of layers, films, panels, regions, etc., are exaggerated for clarity. In the drawings, for better understanding and ease of description, the thicknesses of some layers and areas are exaggerated.

It will be understood that when an element such as a layer, film, region, or substrate is referred to as being “on” another element, it can be directly on the other element or intervening elements may also be present. In contrast, when an element is referred to as being “directly on” another element, there are no intervening elements present. In addition, the word “˜ on” means positioning on or below the object portion, but does not essentially mean positioning on the upper side of the object portion based on a direction opposite to gravity.

In addition, unless explicitly described to the contrary, the word “comprise”, and variations such as “comprises” or “comprising”, will be understood to imply the inclusion of stated elements but not the exclusion of any other elements.

Further, in the specification, the phrase “in a plan view” means when a portion of an object is viewed from above, and the phrase “in a cross-section” means when a cross-section taken by vertically cutting an object portion is viewed from the side.

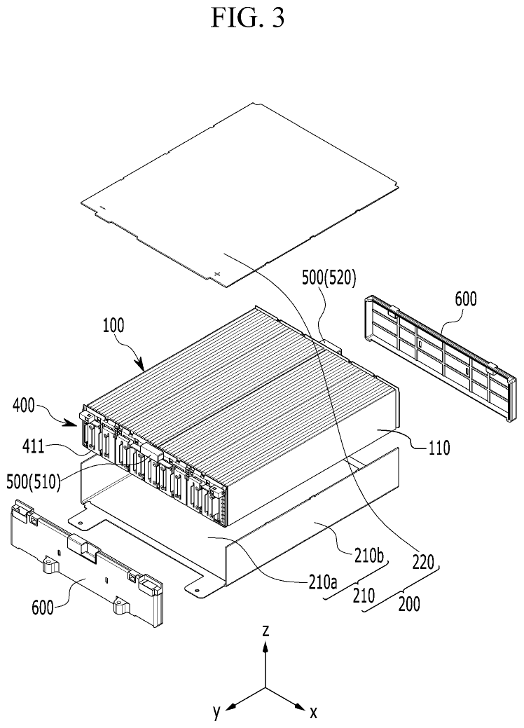

FIG. 3 is an exploded perspective view of a battery module according to an exemplary embodiment of the present invention.

As illustrated in FIG. 3, a battery module according to an embodiment of the present invention includes a battery cell stack 100 in which a plurality of battery cells 110 are stacked, a frame 200 receiving the battery cell stack 100, a busbar frame 400 formed on the front/rear surfaces of the battery cell stack 100, and an end plate 600 covering the outside of the busbar frame 400 based on the battery cell stack 100.

The battery cell 110 according to the present embodiment is a secondary battery and may be configured as a pouch-type secondary battery. The battery cells 110 may be configured in plurality, and a plurality of battery cells 110 may be stacked on each other and be electrically connected to each other to form a battery cell stack 100. A plurality of battery cells 110 may include an electrode assembly, a cell case, and an electrode lead protruding from the electrode assembly, respectively.

The busbar frame 400 may be equipped with a busbar 411 and a connector 500. The connector 500 may sense a voltage and temperature from the busbars mounted on the busbar frame 400 or a thermistor and transmit it to a BMS (Battery Management System). Among the busbar frames 400 formed on the front/rear surfaces of the battery cell stack 100, a first connector 510 may be formed on the busbar frame 400 positioned at the front surface of the battery cell stack 100, and a second connector 520 may be formed on the busbar frame 400 positioned at the rear surface of the battery cell stack 100.

Conventionally, a connector was formed on only one of two busbar frames formed on the front and rear surfaces of the battery cell stack 100, and the busbar frame on which a connector was not formed transmitted the voltage and temperature sensing information to the connector located on the opposite side of the reference of the battery cell stack through a flexible flat cable. In this arrangement, the process of assembling the flexible flat cable and the process of checking whether there is any problem in the connection through the flexible flat cable were separately required by positioning the flexible flat cable on the upper side of the battery cell stack.

According to an exemplary embodiment of the present invention, the first and second connectors 510 and 520 are separately formed on one side of each busbar frame 400 formed on the front and rear surfaces of the battery cell stack 100, so that the sensed voltage and temperature may be transmitted to the BMS in both directions through the connectors formed on each busbar frame 400 without any need of the separate assemble of the flexible flat cable. Through this, a manufacturing cost of the battery module may be reduced and the structure of the battery module may be simplified. In addition, the assembly process of the flexible flat cable and the process of checking the connection defects are eliminated, thereby simplifying the battery module manufacturing process.

The battery cell stack 100 is disposed in the frame 200. According to the present embodiment, the frame 200 may include a lower frame 210 covering the lower surface and both side surfaces of the battery cell stack 100, and an upper plate 220 covering the upper surface of the battery cell stack 100.

When the busbar frame 400 is mounted on the front/rear surfaces of the battery cell stack 100, the battery cell stack 100 may be disposed on the lower frame 210. Thereafter, the upper plate 220 may be assembled to cover the upper part of the battery cell stack 100. At this time, by fixing the upper plate 220 and the lower frame 210, the battery cell stack 100 may be stably disposed within the frame 200.

The lower frame 210 of the frame 200 that accommodates the battery cell stack 100 may be a U-shaped frame. The U-shaped frame 210 may include a bottom part 210a and two side parts 210b extending upward from both ends of the bottom part 210a. The bottom part 210a may cover the lower surface (a direction opposite the z-axis) of the battery cell stack 100, and the side parts 210b may cover both sides (in an x-axis direction and opposite to the x-axis direction) of the battery cell stack 100.

The upper plate 220 may be formed as a single plate-shaped structure surrounding the upper surface (the z-axis direction) except for the lower surface and the both sides covered by the U-shaped frame 210. The upper plate 220 and the U-shaped frame 210 may form a structure that covers the battery cell stack 100 up, down, left, and right by being joined by welding or the like while the corresponding corners are in contact with each other. The battery cell stack 100 may be physically protected through the upper plate 220 and the U-shaped frame 210. To this end, the upper plate 220 and the U-shaped frame 210 may include a metal material having predetermined strength.

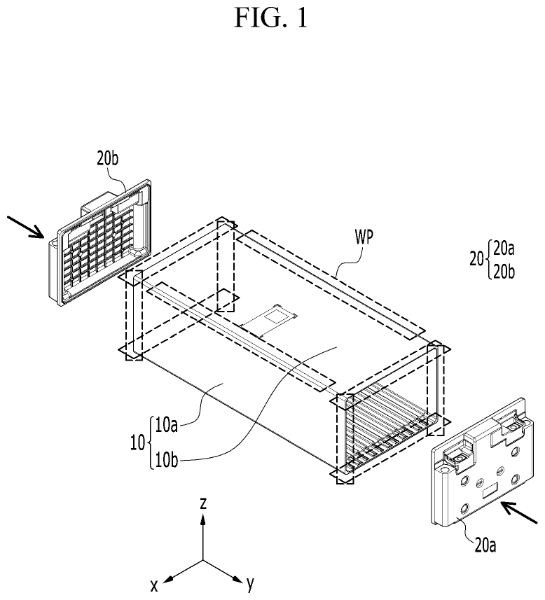

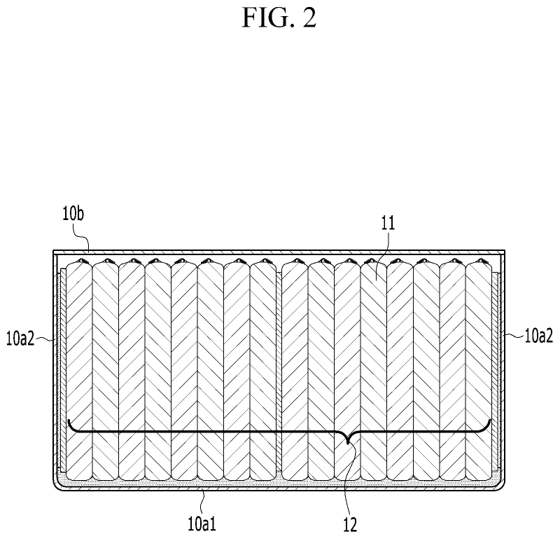

As previously described with reference to FIG. 1 and FIG. 2 where the battery cell stack 100 is mounted inside the frame 200, welding may be performed to join the U-shaped frame 210 and the upper plate 220 of the frame 200. In this arrangement, to form the welding part, it is necessary to fix the U-shaped frame 210 and the upper plate 220 so that the joint surfaces of the side part 210b of the U-shaped frame 210 and the upper plate 220 are positioned corresponding to each other. However, there is a limit to fixing the U-shaped frame 210 and the upper plate 220 to closely correspond to each other, and this has a problem in that the welding is not performed smoothly.

In addition, laser welding may be used to perform the welding, and damage to internal parts including the battery cells may be caused by the laser itself or penetrating welding spatter during the welding process. In such a case, if the assembly defect occurs during the assembly process, in which the upper plate 220 is placed on the U-shaped frame 210, the weld line is also misaligned, and a larger amount of welding spatter flows into the battery module where the battery cells are located, thereby causing problems.

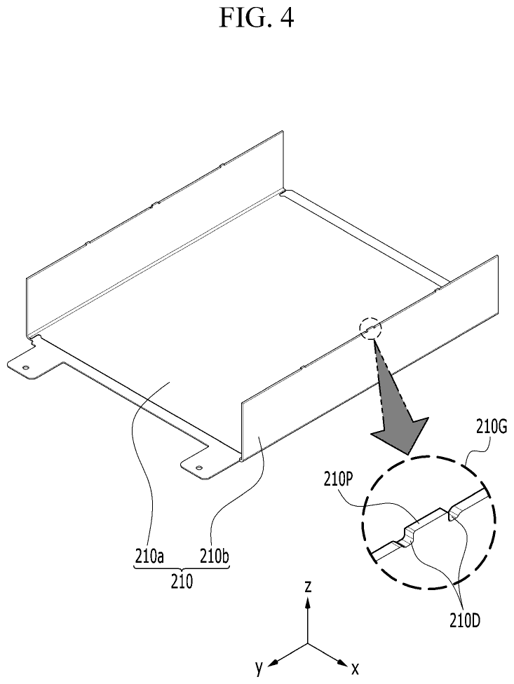

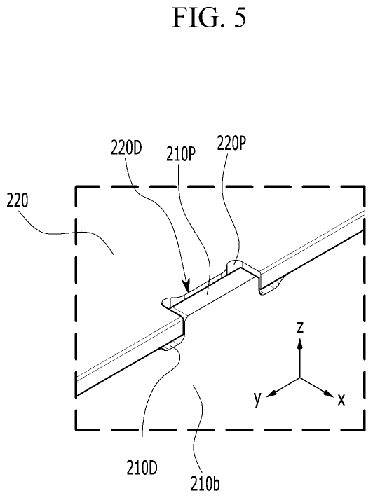

In order to reduce this problem, the battery module according to the present embodiment includes a lower frame having a protruding assembly guide structure, thereby improving the assembly ability of the lower frame and the upper plate, thereby preventing the welding defects. This will be described in detail with reference to FIG. 4 and FIG. 5.

FIG. 4 is a perspective view of a lower frame included in the battery module of FIG. 3. FIG. 5 is a partial perspective view of an assembly part of an upper plate and a lower frame in a battery module according to an exemplary embodiment of the present invention.

As illustrated in FIG. 4, the upper corner of the side part 210b of the U-shaped frame 210 according to the present embodiment may form an assembly guide part 210G. The assembly guide part 210G may be formed as at least one on the upper corner of the side part 210b of the U-shaped frame 210. A plurality of assembly guide parts 210G may be formed to be spaced apart from each other while having a predetermined interval therebetween.

The assembly guide part 210G according to the present embodiment may include a supporting part 210P protruding in the z-axis direction and a depressed part 210D formed on both sides of the supporting part 210P. The depressed part 210D may have an escape shape in which the upper corner of the side part 210b of the U-shaped frame 210 is concave in a direction opposite to the z-axis.

As illustrated in FIG. 5, a groove part 220D corresponding to the assembly guide part 210G formed on the U-shaped frame 210 may be formed on the upper plate 220 according to the present embodiment. The groove part 220D may have a structure in which both corners of the upper plate 220 are depressed in a direction facing each other so that the assembly guide part 210G of the U-shaped frame 210 may be assembled with the upper plate 220. In this case, an escape part 220P may be formed on both ends of the groove part 220D. The escape part 220P minimizes a gap of the groove part 220D so that the supporting part 210P of the assembly guide part 210G may be accurately coupled to the groove part 220D.

According to the present embodiment, by fixing the positions in the x-axis direction and the y-axis direction, not only can the assembly ability be improved, but also the durability of the battery module can be improved.

As illustrated in FIG. 3, like the battery cell stack 100 according to an exemplary embodiment of the present invention, in the case of a large area module in which the number of the stacked battery cells 110 is larger than the number of battery cells 11 in the battery cell stack 12 shown in FIG. 2, the length of the battery module in a horizontal direction becomes longer. In the large area module, since the length of the battery module in the horizontal direction is increased, the load at the center is large and the possibility of a bending deformation increases. Here, the length in the horizontal direction may mean a length in the direction in which the battery cells are stacked. Due to the bending deformation, the coupling structure of the U-shaped frame 210 and the upper plate 220 may be distorted depending on the battery module usage condition, but according to the present embodiment, the coupling retention between the U-shaped frame 210 and the upper plate 220 may be improved through the strong position fixation in both the x-axis direction and the y-axis direction.

Again, as illustrated in FIG. 3, the battery module according to the present embodiment may further include an end plate 600 covering the front/rear surfaces of the battery cell stack 100. Through the frame 200 described above, it is possible to physically protect the battery cell stack 100 disposed inside. The end plate 600 may be positioned on the front (a direction opposite to the y-axis) and the rear (in a direction of the y-axis direction) of the battery cell stack 100. This end plate 600 is formed to cover the battery cell stack 100, and it is possible to physically protect the battery cell stack 100 and other electronic devices from external impact.

Meanwhile, although not specifically shown, a busbar frame 400 to which the busbar 411 is mounted and an insulating cover for an electrical insulation, etc. may be positioned between the battery cell stack 100 and the end plate 600.

One or more battery modules according to an exemplary embodiment of the present invention may be packaged in a pack case to form a battery pack. The battery pack may be formed by mounting at least one battery module together with various control and protection systems such as a battery management system (BMS) and a cooling system.

The battery module described above and the battery pack including the same may be applied to various devices. The device may be applied to a vehicle such as an electric bicycle, an electric vehicle, and a hybrid vehicle, but is not limited thereto, and may be applied to various devices that may use the secondary battery.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

1. A battery module comprising:
a battery cell stack comprising a plurality of battery cells;
a frame surrounding the battery cell stack, wherein the frame includes a lower frame covering a lower surface and both side surfaces of the battery cell stack, and an upper plate covering an upper surface of the battery cell stack;
a busbar frame covering an exposed front surface and an exposed rear surface of the battery cell stack; and
an end plate covering the busbar frame, and
at least one assembly guide part formed at a corner of the lower frame where the lower frame joins the upper plate.

2. The battery module of claim 1, wherein:
the lower frame includes a bottom part supporting the lower surface of the battery cell stack and two side parts extending upward from both ends of the bottom part, respectively, and
the assembly guide part is formed at a corner of an upper end of the corresponding side part of the lower frame.

3. The battery module of claim 2, wherein:
the assembly guide part includes a protruding supporting part and a depressed part formed on two sides of the supporting part.

4. The battery module of claim 3, wherein:
the depressed part has an escape shape wherein the corner of the upper end of the side part of the lower frame is concave in a direction toward the bottom part of the lower frame.

5. The battery module of claim 3, further comprising:
a groove part formed on the upper plate, wherein the supporting part of the assembly guide part fits into the groove part.

6. The battery module of claim 5, wherein: the groove part has a structure wherein corners of the upper plate are recessed in a direction facing each other.

7. The battery module of claim 6, wherein:
each of two ends of the groove part includes an escape part.

8. A battery pack comprising the battery module of claim 1.
